(19) United States
(12) Patent Application Publication
(10) Pub. No.: US 2023/0306699 A1
(43) Pub. Date: Sep. 28, 2023

(54) VIRTUAL GARMENT WRAPPING FOR DRAPING SIMULATION

(71) Applicant: Amazon Technologies, Inc., Seattle, WA (US)

(72) Inventors: Junbang Liang, Seattle, WA (US); Sunil Sharadchandra Hadap, Dublin, CA (US); Vidya Narayanan, Palo Alto, CA (US)

(21) Appl. No.: 17/701,556

(22) Filed: Mar. 22, 2022

(51) Int. Cl. G06T 19/20; G06T 17/20

(52) U.S. Cl. CPC G06T 19/20; G06T 17/20; G06T 2210/21; G06T 2210/16; G06T 2219/2004

(57) ABSTRACT

Systems and methods are provided for improved 3D garment draping simulation. A garment pattern may be obtained that includes a number of flat, 2D garment panels designated to be connected at seam lines. Triangulated versions of each of the 2D garment panels may then be positioned in 3D virtual space relative to a 3D model of a human body, such that one or more annotated points on each triangulated garment panel are aligned with a corresponding labelled point or region on the 3D body. A warped 3D garment mesh may then be generated by repeatedly applying geometric manipulations to the triangulated garment panels to connect their corresponding seam lines without causing collisions between the triangulated garment panels and the 3D body. This warped 3D garment may then be provided as input to a physics-based draping simulator.

### BACKGROUND

A number of different computer-implemented approaches have been used or proposed for rendering three-dimensional (“3D”) representations of items of clothing worn by or draped over a 3D human model. For example, there is often a need in fields such as 3D computer animation to generate a 3D rendering of particularly items of clothing or an entire outfit as worn by a particular 3D character or model in a manner that appears physically realistic with respect to the clothes' tightness on the particular body, the appearance of wrinkles, the manner in which loose material hangs or falls from particular parts of the body, etc. Draping of clothing on a 3D virtual human body is also useful for a potential purchaser of clothing or a clothing designer to visualize how a particular garment will fit on a particular size and shape of human body. Typically, the most realistic results for garment or clothing draping have been generated using physics-based cloth simulation techniques that are computationally expensive and slow to complete. For example, according to some such simulation techniques, rendering a single item of clothing on a single body model could require over thirty minutes of computing time, which may be prohibitively slow for certain desired uses.

### BRIEF DESCRIPTION OF DRAWINGS

Embodiments of various inventive features will now be described with reference to the following drawings. The drawings are provided to illustrate example embodiments described herein and are not intended to limit the scope of the disclosure.

FIG. 1 is a diagram providing a high-level data flow of garment and body inputs to an initial geometric wrapping process, prior to implementation of a physics-based draping simulation.

FIG. 2 provides a graphical depiction of one instance of triangulated garment panels aligned with corresponding annotated points or regions of a 3D human body model in 3D virtual space.

FIG. 3A provides a graphical depiction of one instance of an initially wrapped garment resulting from applying geometric manipulations to the panels shown in FIG. 2 to connect panels at seam lines while avoiding body collisions.

FIG. 3B provides a graphical depiction of one instance of a draped garment that may be generated by a physics-based draping simulator.

FIG. 4 is a flow diagram of an illustrative method for generating a 3D wrapped garment from 2D garment panel data.

FIG. 5 is a block diagram depicting an illustrative architecture for a computing system that may implement one or more of the features described.

### DETAILED DESCRIPTION

Aspects of the present disclosure relate to improved pre-processing of a two-dimensional (“2D”) garment pattern and 3D human body model prior to implementing a full draping simulator that is configured to render a realistic 3D appearance of the garment by virtually draping the garment on the body model. Garments are typically designed as flat 2D patterns, which often include multiple flat panels designated to be connected to one another at designated seam lines. To understand their fit, these 2D patterns are draped over a 3D body form. This process can be done physically by cutting real fabric and attaching flat patterns over a physical human form or via simulation that accounts for physics (such as gravity, and the particular fabric or material of the garment) and body pose. This simulated draping process provides a realistic view of how the garment may appear over a given body shape, but is generally a slow process that takes substantial computing resources.

For a physics-based draping simulation to run effectively, the garment pattern should be placed accurately around the body form. For example, fabric that should fall over the shoulder should be positioned around the shoulder region such that collisions work as expected. Aspects of the present disclosure include a geometric system that automatically wraps a 2D garment pattern around a template 3D body model. The wrapping process, in some embodiments, may include automatically placing each panel of a garment pattern in virtual 3D space in positions that align points on the garment with corresponding labelled or annotated points or regions on a 3D body mesh, and performing warping and/or other manipulations to the vertices or triangles that make up the triangulated panels to connect corresponding seam lines between different panels while avoiding collisions between the garment panels and the 3D body model.

Although this initial wrapping may not be considered a complete drape (for example, the influence of physics is not captured), it provides a significantly better initialization for a physics-based or deep-learning based physics simulator to subsequently generate or render the complete detailed drape. Existing draping processes and systems typically require users to manually arrange the flat panels of a garment in the user's desired position with respect to a 3D body. This initialization may need to be modified if the draping fails. Such a manual, trial-and-error placement approach to panel placement is not needed according to approaches described herein. Additionally, a large number of initial steps in existing simulation-based draping systems are often dedicated to removing large gaps between seams that need to be connected. The geometric initialization approaches described herein, in contrast, enable a draping simulation to converge more quickly to the fully draped result, thus lowering computational demand and improving runtime of the draping simulation.

According to some embodiments, a computing system described herein may obtain data defining a garment pattern, where the garment pattern includes a number of flat, 2D garment panels designated to be connected at seam lines to form a garment. The system may then triangulate each of the 2D garment panels, and position each of the triangulated garment panels in 3D virtual space relative to a 3D model of a human body, such that one or more annotated points on each triangulated garment panel are aligned in the 3D virtual space with a corresponding labelled point or region on the 3D body. The system may then generate a warped 3D garment mesh by repeatedly applying geometric manipulations to the triangulated garment panels to connect their corresponding seam lines without causing collisions between the triangulated garment panels and the body. This warped 3D garment may then be provided as input to a physics-based or deep learning-based draping simulator.

Garment draping is an important component in virtual try-on systems, such as systems that enable a user to see a preview or rendering of how a particular clothing garment or outfit would fit on a virtual avatar or virtual body resembling the user's actual body. With the help of a well-trained draping network, virtual try-on systems can predict quickly and accurately how garments look and fit on a body. Realistic garment draping is helpful for a clothing designer to visualize how a garment will fit on a variety of bodies, and for redesigning aspects of a garment based on the draped appearance. While virtual try-on for clothing is one use for the systems and methods described herein, accurate and fast virtual cloth draping has uses in many other applications. As an example, fast garment draping may also be a key component in interactive character prototyping for a wide range of applications, such as teleconferencing, computer animations, special effects and computer games.

A number of different approaches have been used for garment draping simulation and may be compatible with (and benefit from) the pre-processing steps described herein. Generally, drape prediction systems or simulators have tended to focus on either physics-based cloth simulation or learning-based garment generation. Physics-based garment simulation systems may include spatial discretization and different forms of simulations. As a faster alternative to simulation, learning based approaches have been developed for draping garments, including normal map generation, KNN body garment fusion, displacement regression, and least square approximation, among others. However, these works each tend to be limited in at least one respect, such as not providing geometric details, not generalizing to a wide range of body shapes, requiring user knowledge of wrinkle formation, and/or not being suitable for loose-fitting clothing (e.g., wrinkle dynamics may be easier to approximate in a fairly realistic manner with tighter fitting garments). Certain methods for draping simulation capable of taking a human body mesh as input and directly regressing a garment mesh as output with realistic geometric details are described in U.S. patent application Ser. No. 17/478,655, to Liang et al., entitled “VIRTUAL GARMENT DRAPING USING MACHINE LEARNING.”

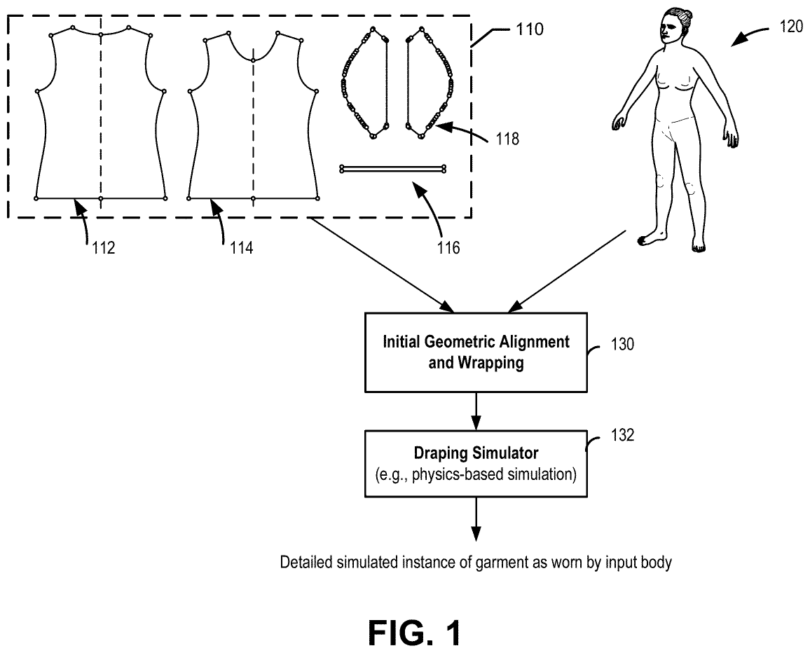

FIG. 1 is a diagram providing a high-level data flow of garment and body inputs to an initial geometric wrapping process, prior to implementation of a physics-based draping simulation. As illustrated in FIG. 1, both a garment pattern 110 and a 3D human body model 120 (which may each be represented in data stored in one or more digital files) may be provided as input to an initial geometric alignment and wrapping process 130. Garment pattern 110 may be composed of a number of garment panels or other components that can be represented in one or more electronic files to indicate the shapes and dimensions (which may be defined based in part on a number of vertices or points) of fabric or other materials to be cut and sewn together (or otherwise connected) to produce an instance of a garment. As shown in FIG. 1, the garment pattern 110 may be for production of a particular dress, and includes back panel 112, front panel 114, collar panel 116, and arm panels 118. It will be appreciated that the particular garment type could be any of a large range of garment types, such as a particular designer's dress, t-shirt, dress shirt, jacket, skirt, etc.

In some embodiments, the file format and content of each garment pattern may follow the digital file structures disclosed in U.S. Patent Application Publication No. 2020/0402126 (hereinafter “the '126 Publication”), to Choche et al., published Dec. 24, 2020, entitled “CUSTOM DIGITAL FILES FOR GARMENT PRODUCTION,” which is incorporated herein by reference. For example, for a specific garment such as a shirt, a digital file serving as the garment pattern may define a plurality of panel objects to represent the components of the shirt. These components may include a front shirt panel object and a back shirt panel object to represent the front of the shirt and the back of the shirt, respectively.

In some embodiments, the computing system may generate a garment pattern by receiving and processing information that is selected or inputted by a human designer via a user interface, as further described in the '126 Publication. Data defined with respect to an individual panel object of a garment pattern may include, for example, a number of points in an x-y coordinate system. The individual points may be associated with one another to define edges of the panel. The edges and/or point locations themselves may each be defined in part by one or more equations or mathematical formulas (such as a formula regarding where one point should be placed relative to another point, or defining a Bezier curve for a curved edge between two points). These and other specific data definitions of a pattern garment are further described in detail with respect to the base digital files and custom digital files of the '126 Publication.

In some embodiments, a garment pattern may define a plurality of objects that each represent physical components that are to be used in production of a garment. In some embodiments, each panel of a garment may be associated with a number of attributes. For example, a front panel of a shirt may be associated with a unique panel identifier to identify that particular panel in the garment as well as a fabric identifier to represent the type of fabric to be used for constructing the front shirt panel. Each pattern may be stored in an object-oriented format (e.g., JavaScript Object Notation (JSON) format), in some embodiments. The file defining a garment pattern may further include sewing instructions dictating how seams represented by a seam object should stitch a first panel object and a second panel object together. Similarly, the file may also include one or more edge objects representing an edge corresponding to a seam, and in turn, a panel. Accordingly, a garment pattern may provide sufficient information and detail for the associated garment to be physically manufactured using known garment manufacturing techniques.

In some embodiments, the panels 112, 114, 116 and 118 of dress pattern 110 may each be stored in annotation data that indicates one or more vertices or points on the panel that are intended to be aligned with particular portions of a human body when the garment is worn. For example, front panel 114 may be stored with an indication that a first point or vertex of the panel 114 should be aligned with the right shoulder of a person and/or that another point or vertex of the panel 114 is intended to align with a point in the middle of a person's hip.

In some embodiments, a deformable human body model, such as the Skinned Multi-Person Linear (“SMPL”) model, may be used to generate the 3D body model 120, such as in the form of a 3D mesh. The SMPL model is a skinned vertex-based model that accurately represents a wide variety of 3D human body shapes in natural human poses, which deform naturally with pose and exhibit soft-tissue motions like those of real humans. The parameters of the model are learned from data including a rest pose template, blend weights, pose-dependent blend shapes, identity-dependent blend shapes, and a regressor from vertices to joint locations. The SMPL model enables training its entire model from aligned 3D meshes of different people in different poses. More information regarding implementation of an SMPL model can be found in U.S. Pat. No. 10,395,411 (hereinafter “the '411 Patent”), to Black et al., issued Aug. 27, 2019, entitled “SKINNED MULTI-PERSON LINEAR MODEL,” which is incorporated herein by reference.

As described in the '411 Patent, using the SMPL model to generate a 3D human body model in a given instance may generally include, in one embodiment, obtaining a shape-specific template of a body model defined by a number of vertices (where the shape-specific template may have been generated by applying a shape-specific blend shape to vertices of a template shape), applying a pose-dependent blend shape to the vertices of the shape-specific template (e.g., displacing the vertices of the shape-specific template into a pose- and shape-specific template of the body model), and then generating a 3D model articulating a pose of the body model based on the vertices of the pose- and shape-specific template of the body model. Thus, an SMPL-based model may be configured to receive input that includes a vector of shape parameters and a vector of pose parameters, which the SMPL model then applies with respect to a template 3D human model in order to generate a 3D human model that maps the shape and pose parameters to vertices. Accordingly, body measurements of a particular person may be used in combination with the SMPL model to obtain or generate a 3D mesh of a human body that approximates the appearance of a particular person's body when rendered for display.

As shown in FIG. 1, once the pattern 110 and 3D body model 120 are retrieved from a data store or otherwise obtained, a computing system may implement an initial geometric alignment and wrapping process 130, as will be further described below. Generally, the geometric alignment and wrapping process 130 may include triangulating each of the panels 112, 114, 116 and 118, placing each panel in virtual 3D space in positions that align points on the garment with corresponding labelled or annotated points or regions on the 3D body mesh 120, and performing warping and/or other manipulations to the vertices or triangles that make up the triangulated panels to connect corresponding seam lines between different panels while avoiding collisions between the garment panels and the 3D body model 120.

After completion of process 130, the resulting initial wrapped garment may then be provided as input to a physics-based draping simulator 132 for generating a more realistic draping of the garment 110 on the 3D body model 120. The draping simulator 132 may generally employ known draping techniques, such as enforcing physics-based constraints and applying wrinkle dynamics. While an existing draping simulator 132 may be used, the draping simulator 132 may have a higher success rate of a successful draping (without requiring human intervention) and a shorter runtime when provided with the output of process 130 as input than if the same draping simulator 132 were provided with the flat garment panels of pattern 110 as input.

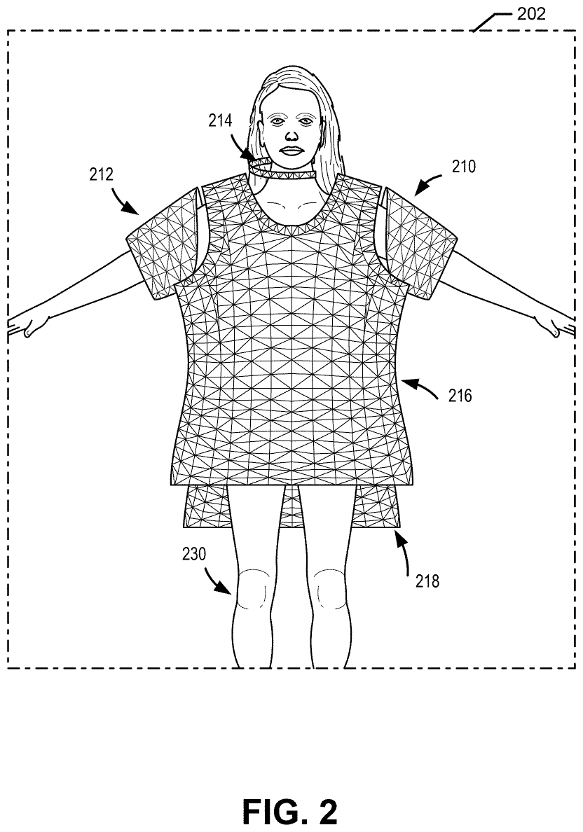

FIG. 2 provides a graphical depiction 202 of one instance of triangulated garment panels aligned with corresponding annotated points or regions of a 3D human body model in 3D virtual space. In graphical depiction 202, the panels of garment pattern 110 discussed above with respect to FIG. 1 (consisting of back panel 112, front panel 114, collar panel 116, and arm panels 118) have been triangulated and positioned around 3D body model 230 as flat triangulated panels (shown as back triangulated mesh 218, front triangulated mesh 216, collar triangulated mesh 214, and arm triangulated meshes 210 and 212). The graphical depiction 202 may be a rendering of 3D virtual space in which the triangulated panels and a 3D mesh body 230 have been arranged, but is presented here only as an example visualization of the virtual space prior to virtually wrapping the garment (in actual implementation, there may not be any graphical depiction similar to depiction 202 necessarily shown to a user).

A computing system described herein may generate the triangulated panels shown in FIG. 2 using known triangulation methods. For example, there are a variety of algorithmic approaches to triangulate a surface or plane in order to generate a mesh or net of triangles. For example, triangulation may generally involve generating a set of points or vertices that are connected with edges to form a plurality of triangles defining the surface. In the instance of FIG. 2, each surface may initially be a flat triangulated plane. It will be appreciated that in other embodiments, polygonal meshes made up of polygons others than triangles (such as quadrilaterals) may be utilized. While graphical depiction 202 displays the 3D human body model 230 with solid surfaces (e.g., the faces of the 3D mesh may have been rendered) and the garment panels in wireframe rendering, this is for ease of depicting the triangulated panels, and the underlying data representing the 3D body model may be a 3D polygonal mesh.

In FIG. 2, the triangulated panels 210, 212, 214, 216 and 218 may have each been automatically positioned within 3D virtual space to align one or more annotated points on each panel with a corresponding labelled or annotated point or region on the body model 230. For example, back triangulated mesh 218 may have been formed from back panel 112 that included annotation data indicating that a particular vertex along the outer edge of the panel should be aligned with a particular labelled vertex on the body model indicating a back-center location of the body's left shoulder. In some embodiments, the system may consider multiple points defined on a single panel to align the panel to best align each of the points (such as minimizing the further distance in the x and y planes of any annotated point in the panel to its corresponding labelled body point). Similarly, the collar triangulated mesh 214 may have been positioned by the system in 3D virtual space to align the collar triangulated mesh 214 with a labelled mid-neck region on the 3D body model 230. In some embodiments, any of a large variety of different 3D body models may be retrieved by the system in a given instance depending on the desires of a user (e.g., the size and shape of body that a user is interesting in draping the garment on), but each body's mesh may include the same number of vertices as one another (such as may be achieved using the SMPL model described above, as one example) with the same body part annotations on corresponding vertices.

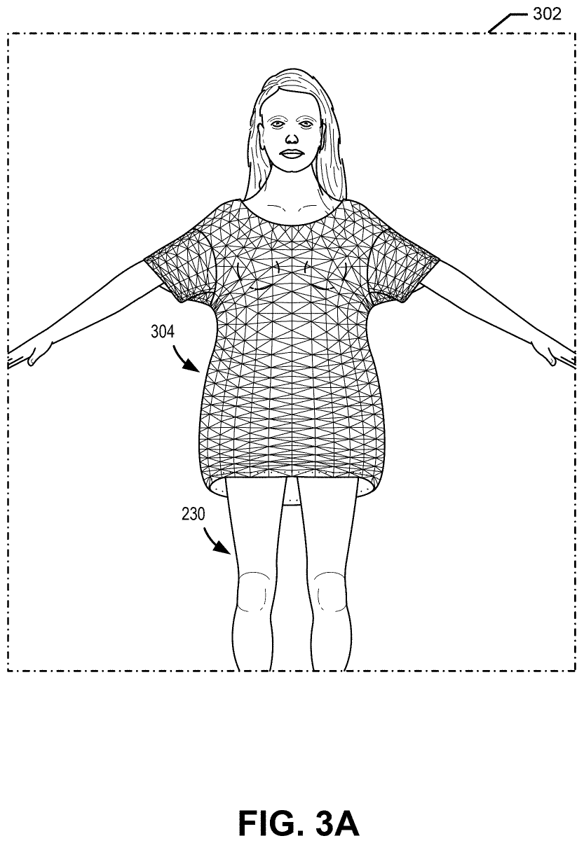

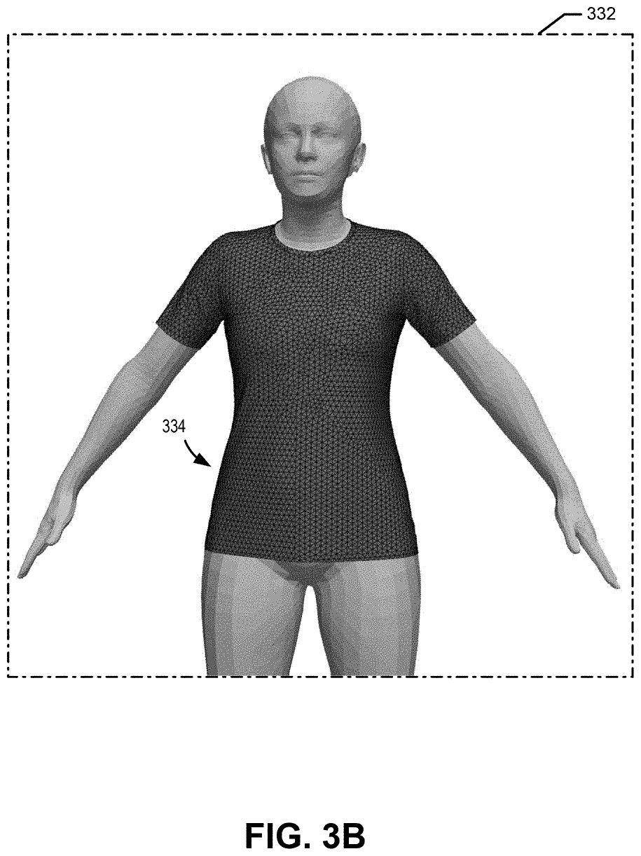

FIG. 3A provides a graphical depiction 302 of one instance of an initially wrapped garment 304 resulting from applying geometric manipulations to the panels shown in FIG. 2 to connect panels at seam lines while avoiding collisions with 3D human body model 230. As illustrated, the warped mesh 304 may be made up of each of triangulated panels 210, 212, 214, 216 and 218 shown above with respect FIG. 2, but these panels have each been warped and/or otherwise manipulated to stretch the panels in 3D virtual space to connect each panel to appropriate other panels (e.g., at seam lines designated to connect to one another in the garment pattern 110). As shown, the system has avoided creating collisions or intersections between the body mesh and any of the triangulated panels making up the resulting warped mesh 304. Thus, if the faces of the 3D mesh of the garment were to be rendered (rather than shown in wireframe form as shown in FIG. 2), the regions of the body that are beneath the warped mesh 304 making up the garment would not be visible (e.g., no points on the body model 304 in the portions of the body where the dress is worn would be visible or protruding through the garment mesh 304).

Depending on the embodiment, the system may attempt to achieve a tighter or looser fit, but would not generally be attempting at the stage illustrated in FIG. 3A to achieve a realistic appearance to the garment fit. Rather, the warped mesh 304 as manipulated to the form shown in FIG. 3A may then be provided as input to a physics-based draping simulator to apply physics and other constraints to achieve a realistic drape. An example, more realistic, drape that may be generated by a physics-based draping simulator (when provided with a warped mesh such as warped mesh 304 as input) is shown as draped garment mesh 334 of FIG. 3B. For example, draped garment mesh 334, unlike the initially warped mesh 304, may include realistic wrinkles, realistic stretching according to material constraints of the particular fabric or other material, and accurately simulated effects of gravity and/or other physics-based constraints.

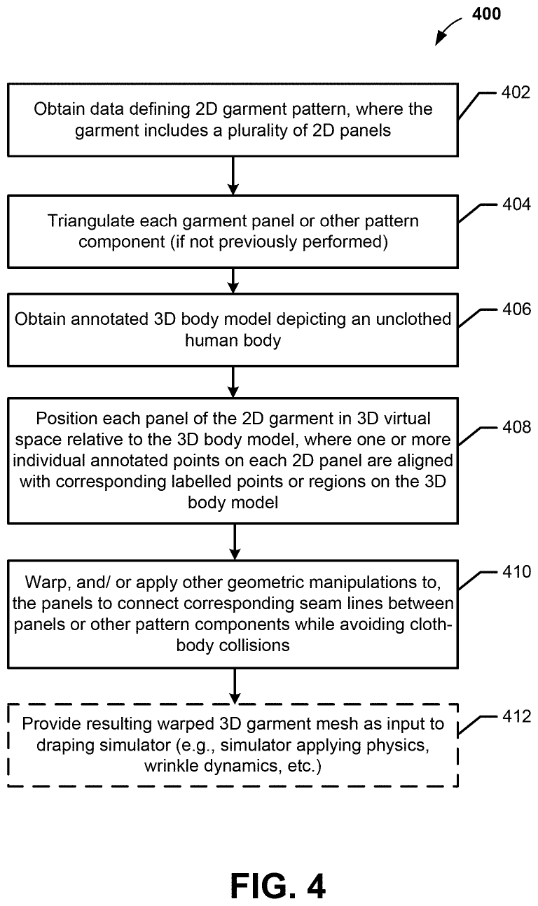

FIG. 4 is a flow diagram of an illustrative method 400 for generating a 3D wrapped garment from 2D garment panel data. The illustrated method may be performed by a computing system, such as computing system 502 that will be described below. For example, in some embodiments, the method 400 may be performed by simulator input generation component(s) 520, other than block 412, which may be performed by draping simulator 522.

The illustrative method 400 may begin at block 402, where the computing system may obtain data defining 2D garment pattern. As discussed above, the garment pattern may include a number of different 2D panels defined by vertices and seam lines. The panel data may include indication of which seam lines on one panel (such as a seam line on one side of a front panel) are to be sewn to or otherwise connected with a particular seam line on another panel (such as a seam line on one side of a back panel) during physical production of the garment. The retrieved panel data may additionally include annotations or labels on particular points or edges indicating a body point or body region where that particular part of the garment should be aligned or worn on a person. In some embodiments, the annotation data may be stored as a human-understandable label or enumerated value indicating a region such as “left shoulder” or “mid-hip.” In other embodiments, the annotation data may identify a particular vertex or other precise location or landmark that exists on each of the 3D body meshes that may be provided as input to the system (e.g., a particular numbered vertex on the body models may always be at approximately the center left shoulder of a body model regardless of the particular body shape and size of that model).

At block 404, the system may triangulate each of the garment panels and/or other pattern components. The result of applying known triangulation techniques, as discussed above, may be a flat triangulated mesh (one mesh for each panel) that is ready to be manipulated in virtual 3D space. Block 404 may be performed in instances where the initially retrieved garment pattern at 402 is not stored in a triangulated form. In other embodiments, the system or another system may have previously generated triangulated versions of the garment's panels (such as in instances where the same garment was previously draped on one or more different body models), in which case the triangulated panels may be retrieved at block 402 without implementing block 404.

Next, at block 406, the system may obtain an annotated 3D body model depicting an unclothed human body. This body model may be selected by a user, such as a clothing designer or a potential customer interested in purchasing the garment. For example, in a clothing design phase, a designer may utilize the system to preview how a garment that the designer is designing will fit on particular body types in order to consider alterations or changes to the garment pattern prior to garment production. In other embodiments, the system may be utilized by a potential customer of a retailer or clothing manufacturer (which may be a “made to measure” or custom clothing manufacturer) to virtually “try on” a garment to preview the how the garment would fit on a virtual body similar to that customer's body. In those instances, the 3D body model may be a model generated based on the customer's actual body measurements (such as using an SMPL model described above). The body model may generally be in the form of a 3D mesh, according to some embodiments.

At block 408, the system may position each panel of the 2D garment in 3D virtual space relative to the 3D body model, where one or more individual annotated points on each 2D panel are aligned with corresponding labelled points or regions on the 3D body model. For example, at least one panel may be placed generally in front of the 3D body model while at least one other panel is placed generally behind the 3D body model. The placement of a given panel, as discussed above, may be based on matching or aligning the point annotations or region annotations between the annotated panel data and the 3D body model data. In some embodiments, the panels may be placed such that they do not collide or interest in 3D space with any portion of the body model. For example, if a particular point on a front panel is indicated to be aligned with a particular point on the body model, the panel may not be placed at the same (x, y, z) coordinate position as the corresponding vertex on the body model. Rather, the system may generally align those points while placing the panel as a whole at a sufficient distance (such as along normals) from the body model such that no points on the body model collide with the panel mesh. Accordingly, panels that are indicated in the pattern data as intended to connect with each other (such as a front panel and back panel) may not initially touch each other in the initial positioning of these panels at block 408 (e.g., the body model placed between the front and back panels may create significant distance in 3D space between the initially positioned flat front and flat back panels).

At block 410, the system may warp and/or apply other geometric manipulations to the panels to connect corresponding seam lines between panels or other pattern components while avoiding cloth-body collisions. For example, geometric algorithms may be implemented to essentially push vertices of the triangulated panel meshes apart to connect appropriate seam lines between panels (e.g., bring the corresponding edges of two panels together along seam lines) while also avoiding panel-body collisions. This may include rotating and translating triangles of a panel mesh to avoid intersection. While this may result in unrealistic amounts of stretching relative to how a real fabric would stretch, this may generally be acceptable because the resulting warped mesh will be refined during a full realistic draping process that implements physics-based and other constraints (such as in block 412 below).

In some embodiments, block 410 may be implemented by offsetting triangles along normals until collision is avoided, followed by an alternating step to minimize area distortion and stitch triangles back together. Further, one or more triangles or regions of a mesh may be subdivided, if needed in a given instance in order to join panels without causing collisions, according to some embodiments. The collision avoidance and distortion minimization may be iteratively repeated until a reasonable initialization is achieved. What is reasonable may depend on how close of a fit is desired in a given instance and/or on the particular draping simulator that the warped garment will then be provided to as input for a complete physics-based draping. In general, the warped 3D mesh, regardless of the particular threshold or test used to determine that the initialization has reached a sufficient stopping point in a given embodiment, may improve the speed and ability of the draping simulator to implement a physics-based draping (relative to merely providing the flat panels as input to the draping simulator, as may be done in existing systems).

At block 412, the system may provide the resulting warped 3D garment mesh (generated at block 410) as input to draping simulator (e.g., a simulator applying physics, wrinkle dynamics, and/or other constraints). In other embodiments, the method 400 may end with storing the warped 3D garment to be used at a later time in a physics-based or deep learning-based draping simulation. For example, the 3D mesh may be stored in a file format suitable for providing as input to a particular existing draping simulator that will be utilized by the system or another system for the full draping.

In some embodiments, the system may store a record of the manipulations or transformations that were applied to the garment mesh in order to reuse or transfer the manipulations to another similar garment in the future, such as another garment of the same type (e.g., a different dress in the case of a dress, or a different shirt in the case of a shirt). For example, the system may apply the same rotations, translations and/or other manipulations to a second garment of the same type. In some embodiments, the second garment may be a garment with a different appearance from the first garment, but with similar boundaries and/or with a co-parameterized mesh. For example, the garments may have the same set of vertices, but may have different internal meshes, in one embodiment.

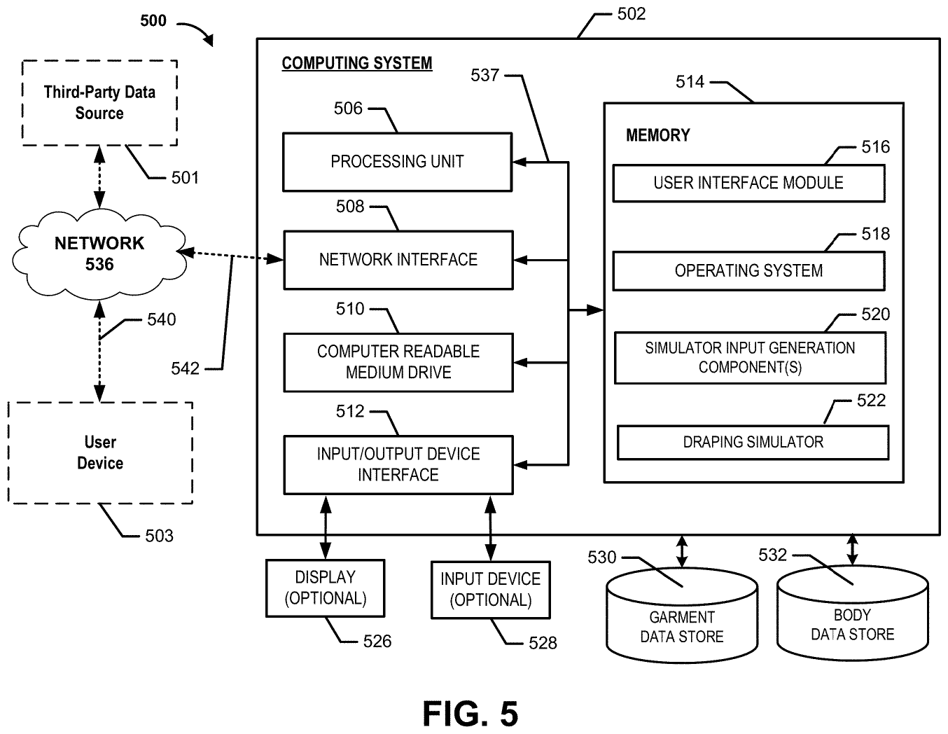

FIG. 5 illustrates a general architecture of a computing environment 500, according to some embodiments. As depicted in FIG. 5, the computing environment 500 may include a computing system 502. The general architecture of the computing system 502 may include an arrangement of computer hardware and software components used to implement aspects of the present disclosure. The computing system 502 may include many more (or fewer) elements than those shown in FIG. 5.

As illustrated, the computing system 502 includes a processing unit 506, a network interface 508, a computer readable medium drive 510, an input/output device interface 512, an optional display 526, and an optional input device 528, all of which may communicate with one another by way of a communication bus 537. The processing unit 506 may communicate to and from memory 514 and may provide output information for the optional display 526 via the input/output device interface 512. The input/output device interface 512 may also accept input from the optional input device 528, such as a keyboard, mouse, digital pen, microphone, touch screen, gesture recognition system, voice recognition system, or other input device known in the art.

The memory 514 may contain computer program instructions (grouped as modules or components in some embodiments) that the processing unit 506 may execute in order to implement one or more embodiments described herein. The memory 514 may generally include RAM, ROM and/or other persistent, auxiliary or non-transitory computer-readable media. The memory 514 may store an operating system 518 that provides computer program instructions for use by the processing unit 506 in the general administration and operation of the computing system 502. The memory 514 may further include computer program instructions and other information for implementing aspects of the present disclosure. For example, in one embodiment, the memory 514 may include a user interface module 516 that generates user interfaces (and/or instructions therefor) for display upon a computing system, e.g., via a navigation interface such as a browser or application installed on a user device 503.

In some embodiments, the memory 514 may include one or more simulator input generation components 520 and a draping simulator 522, which may be executed by the processing unit 506 to perform operations according to various embodiments described herein. For example, the simulator input generation components 520 may implement the initial geometric alignment and wrapping processes (such as described with respect to method 400 above), the output of which may be provided to the draping simulator 522 (which, in some embodiments, may be a known physics-based draping simulator). The modules or components 520 and/or 522 may access the body data store 532 and/or garment data store 530 in order to retrieve data described above (such as 3D body representations and garment patterns) and/or store data (such as warped garment meshes). The data stores 530 and/or 532 may be part of the computing system 502, remote from the computing system 502, and/or may be a network-based service.

In some embodiments, the network interface 508 may provide connectivity to one or more networks or computing systems, and the processing unit 506 may receive information and instructions from other computing systems or services via one or more networks. In the example illustrated in FIG. 5, the network interface 508 may be in communication with a user device 503 (which may be operated, for example, by a garment designer or a potential customer interested in previewing the fit of a garment on a particular body) via the network 536, such as the Internet. In particular, the computing system 502 may establish a communication link 542 with a network 536 (e.g., using known protocols) in order to send communications to the computing device 503 over the network 536. Similarly, the computing device 503 may send communications to the computing system 502 over the network 536 via a wired or wireless communication link 540. In some embodiments, the computing system 502 may additionally communicate via the network 536 with an optional third-party data source 501, which may be used by the computing system 502 to retrieve garment data (such as in association with an electronic catalog of garments), user body data, and/or other data.

Those skilled in the art will recognize that the computing system 502 and user device 503 may be any of a number of computing systems or devices including, but not limited to, a laptop, a personal computer, a personal digital assistant (PDA), a hybrid PDA/mobile phone, a mobile phone, a smartphone, a wearable computing device, a digital media player, a tablet computer, a gaming console or controller, a kiosk, an augmented reality device, another wireless device, a set-top or other television box, one or more servers, and the like. The user device 503 may include similar hardware to that illustrated as being included in computing system 502, such as a display, processing unit, network interface, memory, operating system, etc.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or one or more computer processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
a non-transitory data store that stores data defining a three-dimensional (“3D”) model of a human body;
at least one computing device configured with computer-executable instructions that, when executed, cause the at least one computing device to:
obtain data defining a garment pattern, wherein the garment pattern comprises a plurality of two-dimensional (“2D”) garment panels designated to be connected at seam lines of the 2D garment panels to form a garment;
triangulate each of the 2D garment panels to generate a plurality of triangulated garment panels;
retrieve the 3D model of the human body from the non-transitory data store, wherein the 3D model of the human body includes a plurality of labelled points or regions on the human body;
position each of the triangulated garment panels in 3D virtual space relative to the 3D model of the human body, wherein at least a first triangulated garment panel is placed in front of the 3D model in the 3D virtual space and a second triangulated garment panel is placed behind the 3D model in the 3D virtual space, wherein one or more annotated points on each triangulated garment panel are aligned in the 3D virtual space with a corresponding labelled point or region on the 3D model of the human body;
generate a warped 3D garment mesh by repeatedly applying geometric manipulations to the triangulated garment panels to connect their corresponding seam lines without causing collisions between the triangulated garment panels and the 3D model of the human body;
provide the warped 3D garment mesh as input to a draping simulator configured to apply physics-based 3D draping of garments; and
generate, as output of the draping simulator when provided with the warped 3D garment mesh as input, a 3D rendering of the garment as worn on the human body.

2. The system of claim 1, wherein repeatedly applying the geometric manipulations to the triangulated garment panels comprises offsetting triangles of at least one triangulated garment panel along normals and subdividing one or more triangles.

3. The system of claim 2, wherein repeatedly applying the geometric manipulations to the triangulated garment panels further comprises minimizing area distortion and stitching together two or more triangles of the at least one triangulated garment panel.

4. A computer-implemented method comprising:
obtaining data defining a garment pattern for producing a garment, wherein the garment pattern comprises a plurality of triangulated garment panels, wherein each of the triangulated garment panels is designated to be connected to at least one other triangulated garment panel at corresponding seam lines;
obtaining a 3D model of a human body, wherein the 3D model of the human body includes a plurality of labelled points or regions on the human body;
positioning each of the triangulated garment panels in 3D virtual space relative to the 3D model of the human body, wherein at least a first triangulated garment panel is placed in front of the 3D model in the 3D virtual space and a second triangulated garment panel is placed behind the 3D model in the 3D virtual space, wherein one or more annotated points on each triangulated garment panel are aligned in the 3D virtual space with a corresponding labelled point or region on the 3D model of the human body;
generating a warped 3D garment mesh by repeatedly applying geometric manipulations to the triangulated garment panels to connect their corresponding seam lines without causing collisions between the triangulated garment panels and the 3D model of the human body, wherein the warped 3D garment mesh is generated without applying physics-based manipulations; and
storing, in an electronic data store, the warped 3D garment mesh as a file type suitable for input to a physics-based garment draping simulator.

5. The computer-implemented method of claim 4, wherein the first triangulated garment panel is initially positioned in the 3D virtual space, prior to applying the geometric manipulations, such that the first triangulated garment panel does not touch or intersect any other triangulated garment panel.

6. The computer-implemented method of claim 5, wherein, subsequent to repeatedly applying the geometric manipulations, the first triangulated garment panel is connected along two or more seam lines with the second triangulated garment panel.

7. The computer-implemented method of claim 4, wherein the first triangulated garment panel and the second triangulated garment panel are each flat prior to applying the geometric manipulations.

8. The computer-implemented method of claim 4, wherein repeatedly applying geometric manipulations to the first triangulated garment panel comprises pushing a plurality of vertices of the first triangulated garment panel apart to avoid collision with the 3D model of the human body.

9. The computer-implemented method of claim 4, wherein repeatedly applying geometric manipulations to the first triangulated garment panel comprises rotating and translating individual triangles of the first triangulated garment panel.

10. The computer-implemented method of claim 4 further comprising:
providing the warped 3D garment mesh as input to the garment draping simulator, wherein the garment draping simulator is configured to apply physics-based 3D draping techniques; and
generating, as output of the garment draping simulator when provided with the warped 3D garment mesh as input, a 3D rendering of the garment as worn on a human body.

11. The computer-implemented method of claim 4, wherein generating the warped 3D garment mesh further comprises reducing area distortion in at least one triangulated garment panel after applying one or more geometric manipulations to the at least one triangulated garment panel.

12. The computer-implemented method of claim 4, wherein repeatedly applying the geometric manipulations to the triangulated garment panels comprises offsetting triangles of at least one triangulated garment panel along normals.

13. A non-transitory computer readable medium including computer-executable instructions that, when executed by a computing system, cause the computing system to perform operations comprising:
obtaining data defining a garment pattern for producing a garment, wherein the garment pattern comprises a plurality of triangulated garment panels, wherein each of the triangulated garment panels is designated to be connected to at least one other triangulated garment panel at corresponding seam lines;
obtaining a 3D model of a human body, wherein the 3D model of the human body includes a plurality of labelled points or regions on the human body;
positioning each of the triangulated garment panels in 3D virtual space relative to the 3D model of the human body, wherein the 3D model of the human body is positioned between at least a first triangulated garment panel and a second triangulated garment panel in the 3D virtual space, wherein one or more annotated points on each triangulated garment panel are aligned in the 3D virtual space with a corresponding labelled point or region on the 3D model of the human body; and
generating a warped 3D garment mesh by repeatedly applying geometric manipulations to the triangulated garment panels to connect their corresponding seam lines without causing collisions between the triangulated garment panels and the 3D model of the human body, wherein the warped 3D garment mesh is generated without applying physics-based manipulations.

14. The non-transitory computer readable medium of claim 13, wherein the first triangulated garment panel and the second triangulated garment panel are each flat prior to applying the geometric manipulations.

15. The non-transitory computer readable medium of claim 13, wherein repeatedly applying geometric manipulations to the first triangulated garment panel comprises pushing a plurality of vertices of the first triangulated garment panel apart to avoid collision with the 3D model of the human body.

16. The non-transitory computer readable medium of claim 13, wherein repeatedly applying geometric manipulations to the first triangulated garment panel comprises rotating and translating individual triangles of the first triangulated garment panel.

17. The non-transitory computer readable medium of claim 13, wherein the operations further comprise:
providing the warped 3D garment mesh as input to a garment draping simulator, wherein the garment draping simulator is configured to apply physics-based 3D draping techniques; and
generating, as output of the garment draping simulator when provided with the warped 3D garment mesh as input, a 3D rendering of the garment as worn on a human body.

18. The non-transitory computer readable medium of claim 13, wherein generating the warped 3D garment mesh further comprises reducing area distortion in at least one triangulated garment panel after applying one or more geometric manipulations to the at least one triangulated garment panel.

19. The non-transitory computer readable medium of claim 13, wherein repeatedly applying the geometric manipulations to the triangulated garment panels comprises offsetting triangles of at least one triangulated garment panel along normals.
